(19) United States
(12) Patent Application Publication
(10) Pub. No.: US 2005/0281942 A1
(43) Pub. Date: Dec. 22, 2005

(54) Method for forming microlens of image sensor

(76) Inventors: Jeong-Lyeol Park, Chungcheongbuk-do (KR); Nam-Soo Kim, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/094,013

(22) Filed: Mar. 29, 2005

(30) Foreign Application Priority Data
Jun. 18, 2004 (KR) 2004-45729

(51) Int. Cl. B05D 5/06; B05D 5/12

(52) U.S. Cl. 427/66; 427/162; 427/402

(57) ABSTRACT

Disclosed is a method for forming a plurality of microlenses of an image sensor capable of making no gap between the plurality of the microlenses. The method for fabricating a microlens array includes the steps of: depositing a first photoresist layer on a semi-finished substrate; selectively patterning the first photoresist layer, thereby forming a first photoresist layer pattern; forming a plurality of first microlenses by flowing the first photoresist pattern; depositing a second photoresist layer on the first microlenses and the semi-finished substrate; forming a second photoresist pattern between the first microlenses by selectively patterning the second photoresist layer; and forming a plurality of second microlenses between the first microlenses by flowing the second photoresist pattern.

### FIELD OF THE INVENTION

The present invention relates to an image sensor; and more particularly, to a method for forming an image sensor capable of improving a light collecting ability.

### DESCRIPTION OF RELATED ARTS

An image sensor is one of semiconductor devices to convert an optical image to an electric signal. Among the image sensors, a charge coupled device (CCD) is a device that a charge carrier is stored in and transferred to a capacitor as each metal-oxide-silicon (MOS) capacitor is closely located each other.

On the other side, a complementary metal-oxide-silicon (CMOS) image sensor uses a CMOS technology using a control unit and a signal processing circuit as a peripheral circuit, thereby making a metal-oxide-silicon (MOS) transistor as many as the number of pixel. Then, the CMOS image sensor employs a switching method for sequentially detecting an output of the pixel by using the MOS transistor.

As for fabricating these various image sensors, there are a lot of efforts to improve a degree of a photo sensitivity of the image sensors and a light collecting technology is one of these efforts. For instance, the CMOS image sensor includes a photodiode which detects a light and a CMOS logic circuit unit which processes the detected light by using the electric signal and makes data. In order to improve the degree of the photo sensitivity of the image sensor, there is an attempt to increase a ratio which an area of the photodiode takes place out of a whole area of the image sensor, i.e., a fill factor. However, it is impossible to basically remove the CMOS logic circuit unit, thereby showing a limitation of the attempt under a limited area. Accordingly, in order to improve the degree of the photo sensitivity, the light collecting technology collecting a light entering through other regions than the photodiode by changing a channel of the light is introduced and is called a technology for forming a microlens.

FIG. 1 is a cross-sectional view briefly illustrating a conventional image sensor.

Referring to FIG. 1, a color filter array (CFA) 13 forming a unit pixel is placed on a substrate 10 provided with a plurality of photodiodes 11. The CFA has 3 colors of blue, red and green. An over-coating layer (OCM) 14 is formed on the CFA 13 and then, a plurality of microlenses 15 having a convex shape are formed on an upper portion of a region overlapped with the CFA 13.

For a simplicity of FIG. 1, a gate electrode and a light isolation layer are omitted and the gate electrode and the light isolation layer are placed on a region where is not overlapped with the plurality of photodiodes 11 on a lower portion of the insulation layer 12.

The conventional image sensor provided with the above illustrated composition elements refracts the light entering through the region other than the plurality of photodiodes 11 and collects the light at the plurality of photodiodes 11. The OCM 14 is a planarized layer for easily forming a pattern of the plurality of microlenses 15 after forming the CFA 13.

If the conventional image sensor uses the CFA 13, efficiency in using the light decreases, thereby relatively decreasing the degree of the photo sensitivity. In order to compensate a decrease in the degree of the photo sensitivity, the plurality of microlenses 15 are used in accordance with the conventional image sensor. The plurality of microlenses 15 are patterned in a rectangular form by using a photoresist and then, a patterned photoresist is melted by a heat, thereby generating fluidity and forming a sphere due to a surface tension.

Referring to FIG. 1, to increase an amount of a light energy entering into the plurality of photodiodes 11, an effective light detecting region C is enlarged into a light collecting region D due to the plurality of microlenses. Herein, the reference denotations ‘C’ and ‘D’ appearing in FIG. 1 express the effective light detecting region and the light collecting region, respectively.

The conventional plurality of microlenses 15 are formed in a shape of convex and it is important to form the plurality of microlenses 15 to overlap the upper portion of the plurality of photodiodes 11. Accordingly, there is an advantage of increasing efficiency in collecting the light A entering into the plurality of microlenses 15 at the effective light detecting region C. However, the plurality of microlenses 15 should maintain a certain distance E between each other because of an adhesive property that the plurality of microlenses 15 have. This adhesive property of the plurality of microlenses 15 induces a loss of the light B entering through the certain distance E between the plurality of microlenses 15. Herein, a reference denotation ‘A’ expresses the light entering to the plurality of microlenses 15 and a reference denotation ‘B’ expresses the loss of the light. A reference denotation ‘E’ expresses spaces between the plurality of microlenses 15.

FIG. 2 is a top view illustrating a mask structure of a conventional microlens.

When patterning the microlens, a photoresist for the microlens cannot be used out of an I-line until now. That means a gap between the plurality of photoresist patterns PR should not be less than approximately 0.4 μm as shown in FIG. 2.

FIGS. 3A and 3B are photographs of scanning electron microscopy (SEM) illustrating a clung phenomenon of a plurality of conventional microlenses during a flowing process.

If having the fluidity by heating the plurality of photoresist patterns, the plurality of microlenses are extended by approximately 0.1 μm to each side, thereby leaving out approximately 0.2 μm for a gap between the plurality of microlenses. As a result of many experiments, if the gap between the plurality of microlenses is less than approximately 0.2 μm, two microlenses are clung together as shown in FIGS. 3A and 3B. Therefore, the plurality of microlenses become too flat to serve a role of a lens.

Meanwhile, if the gap between the plurality of microlenses is approximately 0.2 μm, the light passed through the gap is damaged as shown in FIGS. 1 and 2. For instance, if applying a design rule of approximately 0.18 μm, in case of using the CMOS image sensor, a size of the mask for the microlense is approximately 3.2 μm×3.2 μm. In this case, if there is a damaging space of approximately 0.2 μm, a light with a amount of approximately (0.2 μm×6.4 μm)/(3.2 μm×3.2 μm), e.g., approximately 12.5%, is lost and thus, it is impossible to expect a product with a high efficiency.

### SUMMARY OF THE INVENTION

It is, therefore, an object of the present invention to provide a method for forming a microlens of an image sensor capable of preventing a plurality of microlenses from cling together during a flowing process and making a gap between the plurality of the microlenses approximately zero.

In accordance with one aspect of the present invention, there is provided a method for fabricating a microlens array, including the steps of: depositing a first photoresist layer on a semi-finished substrate; selectively patterning the first photoresist layer, thereby forming a first photoresist layer pattern; forming a plurality of first microlenses by flowing the first photoresist pattern; depositing a second photoresist layer on the first microlenses and the semi-finished substrate; forming a second photoresist pattern between the first microlenses by selectively patterning the second photoresist layer; and forming a plurality of second microlenses between the first microlenses by flowing the second photoresist pattern.

In accordance with another aspect of the present invention, there is provided a method for fabricating a plurality of microlenses of an image sensor provided with a plurality of unit pixels, including the steps of: selectively forming a first microlens in every other unit pixel region; selectively forming a plurality of second microlenses in the unit pixel where the plurality of first microlenses are not formed; and leaving no gap between the first microlens and the second microlens.

### BRIEF DESCRIPTION OF THE DRAWINGS

The above and other objects and features of the present invention will become better understood with respect to the following description of the preferred embodiment given in conjunction with the accompanying drawings, in which:

FIG. 1 is a cross-sectional view briefly illustrating a conventional image sensor;

FIG. 2 is a top view illustrating a mask structure of a conventional microlens;

FIGS. 3A and 3B are photographs of scanning electron microscopy (SEM) illustrating a clung phenomenon of a plurality of conventional microlenses during a flowing process;

FIGS. 4A to 4E are cross-sectional views illustrating a process for fabricating an image sensor in accordance with the present invention;

FIGS. 5A and 5B are top views illustrating a mask pattern for forming a microlens in accordance with the present invention; and

FIGS. 6A and 6B are photographs of scanning electron microscopy (SEM) illustrating a microlens formed by using a mask pattern in accordance with the present invention.

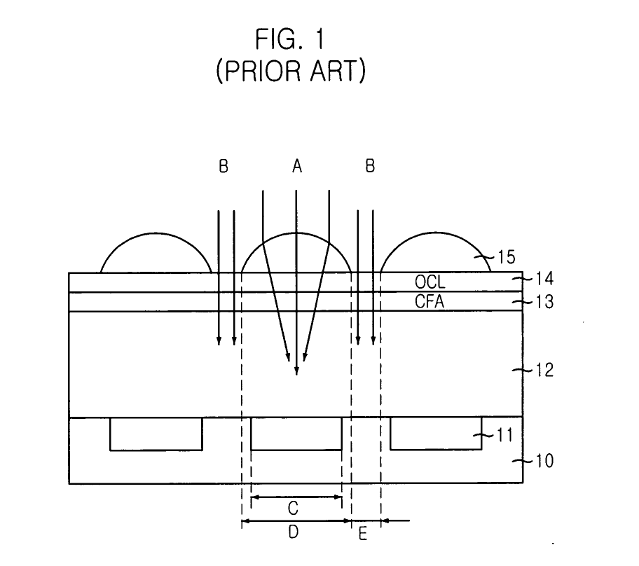

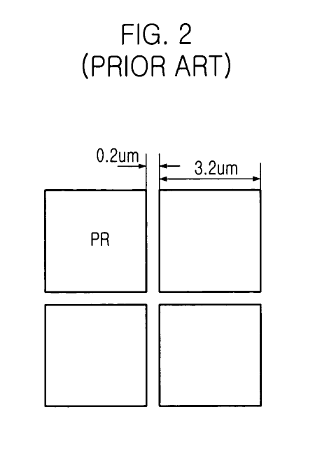

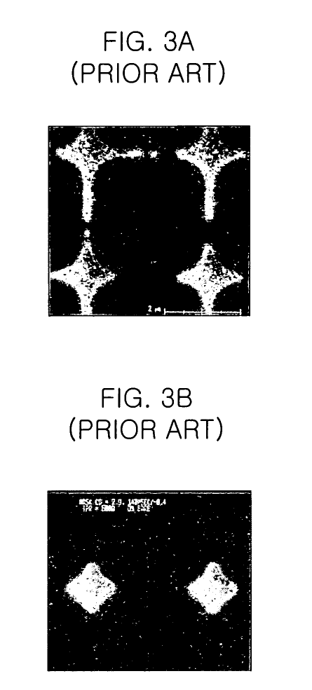

### DETAILED DESCRIPTION OF THE INVENTION

Hereinafter, detailed descriptions on preferred embodiments of the present invention will be provided with reference to the accompanying drawings.

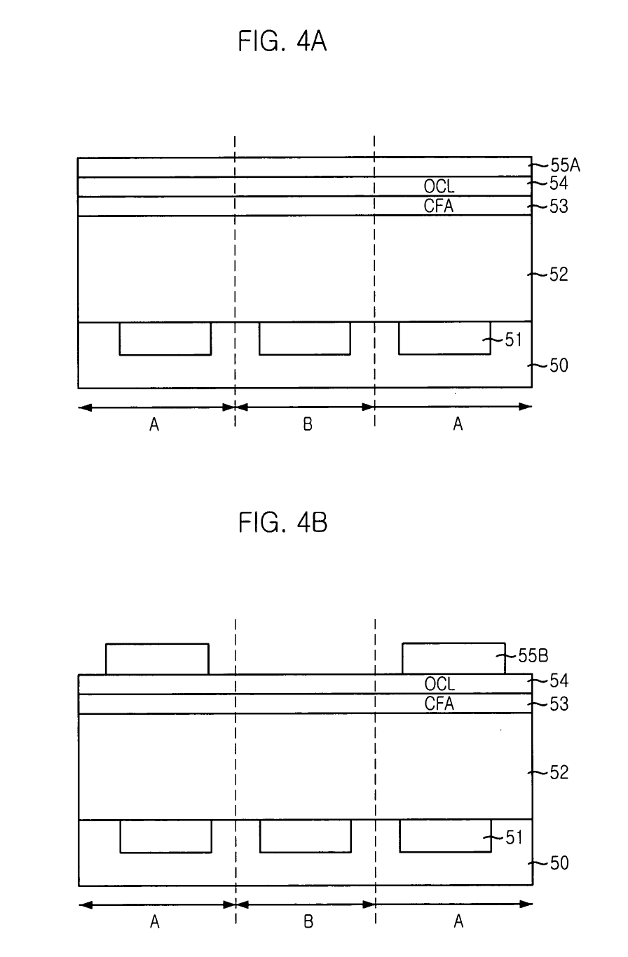

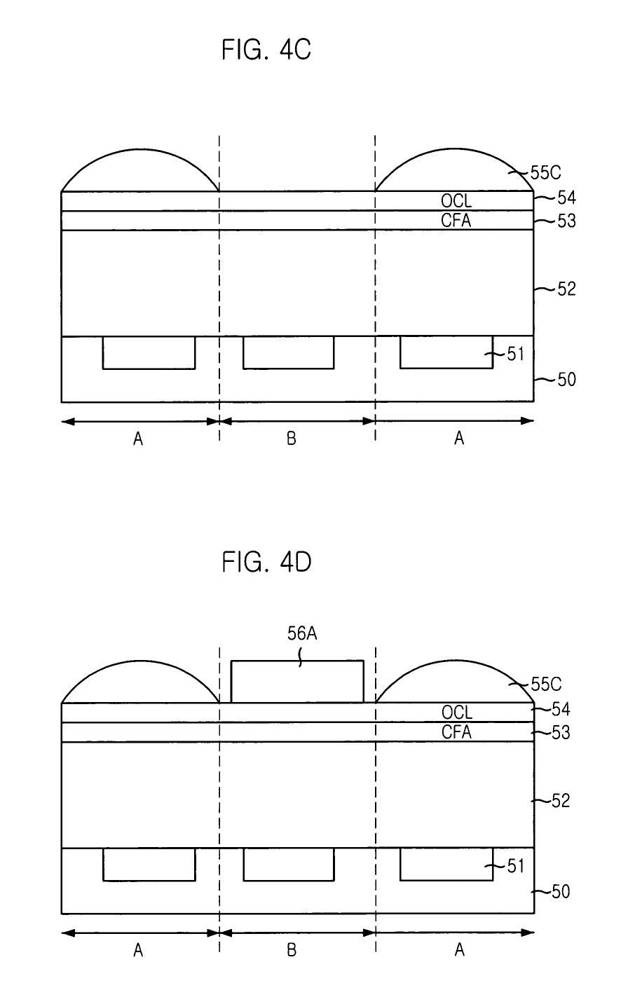

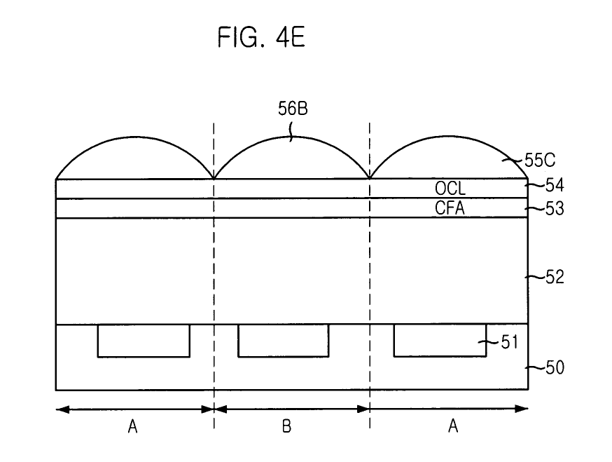

FIGS. 4A to 4E are cross-sectional views illustrating a process for fabricating an image sensor in accordance with the present invention. With reference to FIGS. 4A to 4E, a process for forming the microlens in accordance with the present invention will be examined.

As shown in FIG. 4A, an insulation layer 52, a color filter array (CFA) 53 and an over coating layer (OCL) 54 are sequentially formed on a semi-finished substrate 50 provided with a predetermined lower structure such as a photodiode 51. Then, a photoresist layer 55A is deposited thereon to form a microlens.

Herein, a reference numeral 51 denotes a plurality of photodiodes and each photodiode 51 forms each different unit pixel.

The CFA 53 includes a plurality of color filters identified to have a different color according to each unit pixel. For instance, the color filter of each unit pixel has a color selected from a group consisting of red, blue and green. Meanwhile, if there is not an object of producing a color, it is possible to omit the color filter and the CFA 53.

The OCL 54 is for planarizing the lower layers during forming a subsequent microlens and is typically made up of an oxide based layer.

Subsequently, referring to FIG. 4B, the photoresist layer 55A is selectively patterned, thereby forming a plurality of photoresist patterns 55B only in a plurality of unit pixels only denoted with ‘A’. Herein, both reference denotations ‘A’ and ‘B’ denote a plurality of unit pixels and the plurality of unit pixels A and B are placed in every other region.

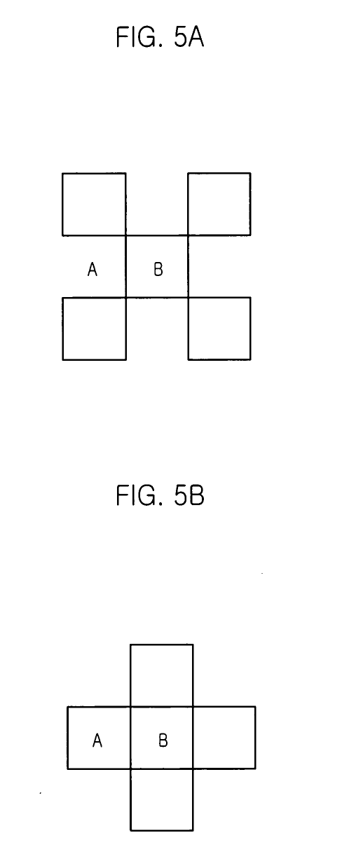

Referring to FIG. 4B, during forming the plurality of photoresist patterns 55B, the photoresist layer 55A is selectively etched by using a mask pattern that will be shown in FIG. 5A.

Subsequently, as shown in FIG. 4C, the plurality of photoresist patterns 55B are flowed by employing a flowing process using bleaching and a heat, thereby forming a plurality of microlenses 55C in a shape of convex due to a surface tension.

At this time, a size of the mask pattern and a thermal process during the flowing process are controlled in order to form the plurality of microlenses 55C up to a portion where the plurality of microlenses 55C touch the plurality of adjacent unit pixels.

Subsequently, referring to FIG. 4D, a photoresist layer for a microlens formation is deposited on all sides where the plurality of microlenses 55C are formed in every other unit pixel region. Afterwards, the photoresist layer is selectively patterned, thereby forming a photoresist pattern 56A only in the unit pixel B. Herein, the unit pixel B is located in every other unit pixel region.

During forming the photoresist pattern 56A, the photoresist layer is selectively etched by using a mask pattern that will be shown in FIG. 5B.

Subsequently, referring to FIG. 4E, the photoresist pattern 56A is flowed by employing a flowing process using bleaching and a heat, thereby forming a microlens 56B in a shape of convex due to a surface tension. The size of the mask pattern and the thermal process during the flowing process are controlled in order to form the microlens 56B up to a portion where the microlens touches the plurality of adjacent unit pixels, e.g., a portion where the plurality of microlenses 55C placed in the plurality of unit pixels A touch the microlens 56B.

At this time, the plurality of microlenses 55C that had already formed in the plurality of unit pixels 55C has been already hardened, thereby not being mixed with the plurality the microlens 56B when forming the microlens 56B in the unit pixel B.

Because of this property, it is possible to form the microlens 56B in the unit pixel B without leaving any gaps between the plurality of microlenses 55C placed in the plurality of unit pixels A and the microlens 56B in the unit pixel B.

FIGS. 5A and 5B are top views illustrating a mask pattern for forming a microlens in accordance with the present invention.

FIG. 5A illustrates the mask pattern used for selectively etching the photoresist layer 55A shown in FIG. 4A. Accordingly, referring to FIG. 5A, in case of applying a positive photolithography process since there is not a mask pattern in a region denoted with a reference denotation ‘A’, the plurality of photoresist patterns 55B remain in the region A and do not remain in the region B as shown in FIG. 4B.

FIG. 5B illustrates the mask pattern used for selectively etching the photoresist layer during forming the photoresist pattern 56A shown in FIG. 4D.

Accordingly, referring to FIG. 5B, in case of applying a positive photolithography process since there is not the mask pattern in the region A, the photoresist pattern 56B remains in the region B shown in FIG. 4D and does not remain in the region B as shown in FIG. 4D.

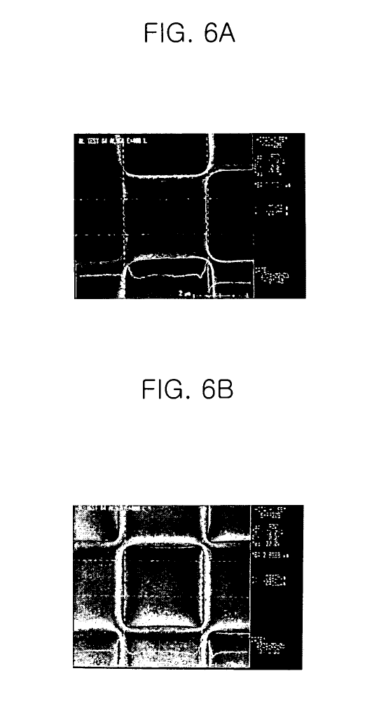

FIGS. 6A and 6B are photographs of scanning electron microscopy (SEM) illustrating a microlens formed by using a mask pattern in accordance with the present invention.

FIG. 6A is a top view corresponding to FIG. 4C. FIG. 6A shows that the plurality of microlenses are formed only in the plurality of unit pixel A and the plurality of microlenses are formed up to a portion where the plurality of microlenses touch the unit pixel adjacent to the plurality of microlenses.

FIG. 6B is a top view illustrating that the microlens is formed only in the unit pixel B. FIG. 6B shows that the microlens is formed up to a portion where the microlens touches the plurality of adjacent unit pixels.

Accordingly, the microlens using a second mask pattern formed after forming the microlens by using a first mask is formed in a blank space almost accurately and a main controllable item of this process can be controllable within a range of approximately maximum 0.05 μm which is same as a capability of a typical photolithography process.

Furthermore, in case of forming the microlens in accordance with the present invention, it is possible to overlap the plurality of microlenses at a minimum by considering variable factors. Accordingly, the gap between the plurality of microlenses can be almost zero.

The present invention can improve a loss of optical efficiency as much as approximately 12.5% by minimizing a light loss due to a gap between the plurality of microlenses of a conventional image sensor. Also, the present invention can prevent a conventional problem that was generated during forming the plurality of microlenses for reducing the gap between each other, i.e., a clung phenomenon that the plurality of adjacent microlenses are clung together.

The present invention provides an effect of greatly improving a capability of an image sensor by increasing an absorptance of a light energy of a unit pixel.

The present application contains subject matter related to the Korean patent application No. KR 2004-0045729, filed in the Korean Patent Office on Jun. 18, 2004, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A method for fabricating a microlens array, comprising the steps of:
depositing a first photoresist layer on a semi-finished substrate;
selectively patterning the first photoresist layer, thereby forming a first photoresist layer pattern;
forming a plurality of first microlenses by flowing the first photoresist pattern;
depositing a second photoresist layer on the first microlenses and the semi-finished substrate;
forming a second photoresist pattern between the first microlenses by selectively patterning the second photoresist layer; and
forming a plurality of second microlenses between the first microlenses by flowing the second photoresist pattern.

2. The method of claim 1, wherein the first microlenses are corresponding to a first unit pixel and a third unit pixel, respectively and the second microlenses are corresponding to a second unit pixel.

3. The method of claim 2, wherein the step of forming the first photoresist pattern, comprising the steps of:
exposing the first photoresist layer placed in the second unit pixel region; and
patterning the first photoresist layer placed in the first and the third unit pixel regions by using a mask pattern covering the first photoresist layer.

4. The method of claim 2, wherein the step of forming the second photoresist pattern, comprising the steps of:
exposing the second photoresist layer placed in the first and third unit pixel regions; and
patterning the second photoresist layer placed in the second unit pixel by using the mask pattern covering the second photoresist layer.

5. The method of claim 1, wherein the second microlenses are closely located between the first microlenses.

6. The method of claim 1, wherein the step of forming the first and the second microlenses uses a thermal process for flowing each of the first and the second photoresist patterns.

7. The method of claim 1, wherein the first and the second microlenses are formed in a shape of convex.

8. A method for fabricating a plurality of microlenses of an image sensor provided with a plurality of unit pixels, comprising the steps of:
selectively forming a plurality of first microlenses in every other unit pixel region;
selectively forming a plurality of second microlenses in the unit pixel where the plurality of first microlenses are not formed; and
leaving no gap between the plurality of first microlenses and the plurality of second microlenses.

9. The method of 8, wherein the first and the second microlenses are formed by employing a flowing process using a thermal process.
